(19) United States
(12) Patent Application Publication
(10) Pub. No.: US 2015/0087277 A1
(43) Pub. Date: Mar. 26, 2015

(54) METHOD AND APPARATUS FOR CALLING AN EXTENSION

(71) Applicant: UC MOBILE LIMITED, Beijing (CN)

(72) Inventors: Jie Liang, Beijing (CN); Zhongkan Li, Beijing (CN)

(21) Appl. No.: 14/379,471

(22) PCT Filed: Mar. 14, 2013
(86) PCT No.: PCT/CN2013/072644

§ 371 Date: Aug. 18, 2014

(30) Foreign Application Priority Data
Mar. 14, 2012 (CN) 201210067291.7

(51) Int. Cl. H04M 7/00

(52) U.S. Cl. CPC H04M 7/003
USPC 455/414.1

(57) ABSTRACT

The present disclosure provides a method and apparatus for calling an extension. In the method, an obtained webpage page text that includes one or more page tag character strings can be parsed. After a document body start tag character string in the webpage page text is parsed out, a predetermined extension corresponding to the document body start tag character string can be called. According to the technical solutions provided by the present disclosure, effects of more flexible modes for modifying a page, adaptability to needs of diverse extension applications and friendly user experience can be achieved.

### FIELD OF THE DISCLOSURE

The present disclosure relates to the field of mobile communication and, more particularly, relates to methods and apparatus for calling an extension.

### BACKGROUND

Currently, in addition to fulfilling daily webpage browsing functions for users, development trend of browser includes continuously enhancing user experience, such as functions of removing advertisement on a webpage, synchronizing bookmarks, forum mode, screenshot, etc. A browser vendor may not want to entirely accomplish, by itself, the functions of extension experience. Instead, the browser vendor may provide an extension development platform, i.e., have third-party developers write extensions based on the browser of the browser vendor. Google browser (Chrome), Apple browser (Safari), Firefox browser (Firefox), and Opera browser (Opera), and the like, have opened corresponding Application Programming Interface (or API) to third-party developers, such that the developers can conveniently develop extensions meeting various needs, based on the browsers.

An important way to implement a browser-based extension is as follows. During the process of parsing a webpage, the browser injects JavaScript defined by the extension that is executed. Via the injected JavaScript, the extension can change structure of the webpage, access resources of the browser, or communicate with a remote server. During the process of the browser parsing a webpage, the ‘point in time’ (or ‘timing’) for injecting the JavaScript usually includes the following three types, i.e., at the beginning of the document (document_start), at the end of the document (document_end), and when the document is idle (document_idle). Extension specification of Chrome browser defines the above three points in time for injection. For the above three points in time for injection, the point in time during the process of parsing a webpage is as shown in Table 1.

TABLE 1

| Point in time | Corresponding point in time of occurrence |
|---|---|
| for injection | during the parsing of a webpage |
| At the beginning of | Indicates that injection is before the Document |
| a document | Object Model (referred to as DOM) tree starts to be |
| (document_start) | built. At this time, start tag nodes of document and |
| | html have been created, but the nodes after html |
| | have not been created. |
| At the end of a | Indicates that injection is after the DOM tree is |
| document | created, but it is possible that certain sub-resources |
| (document_end) | (images or sub-pages iframe) have not completed |
| | being loaded. At this time, the entire DOM tree has |
| | been created, and the JavaScript of extension can |
| | access/modify all nodes of the entire DOM. |
| When the document | Indicates that injection is after the webpage is |
| is idle | loaded, the DOM tree is created, and all of the |
| (document_idle) | sub-resources are loaded. |

The above three points in time for injection can meet the needs of extension applications relatively well. For example, if one wants to change the layout color of a certain type of node on a webpage, at document_start, self-defined custom cascading style sheets (Cascading Style Sheets, referred to as CSS) can be injected. If one wants to hide certain advertisement nodes, at document_end or document_idle, JavaScript can be injected to set the advertisement nodes to be invisible. The points in time for triggering at both document_end and document_idle are after the DOM tree of the webpage is created, with the main difference being whether loading of sub-resources is completed. At document_end, the point in time for triggering is before the loading of the sub-resources is completed and when the loading of the sub-resources is not yet completed. At document_idle, the point in time for triggering is after loading of the sub-resources is completed.

On existing browsers, in order to support the running of an extension, a method for implementing is as follows. During process of loading and parsing a page, the browser calls the script of the extension (e.g., CSS or JavaScript). “Document_start”, “document_end” and “document_idle” are three important injection points in time for the browser calling the script of the extension. FIG. 1 depicts a flow diagram of points in time for injecting scripts during calling of an extension by a browser according to related technology. As shown in FIG. 1, the process flow can include the following process steps.

In Step S102, via Hypertext Transfer Protocol (HTTP) protocol, a browser first requests webpage content from a target site. After receiving responding content, the browser starts to prepare for parsing the page content. For example, the content of the page is:

<html>

<head> </head>
<body>

<div> ... </div>
<div> ... </div>

</body>

</html>

In Step S104, when the webpage parser of the browser parses an html start tag, the webpage parser knows the page is an html page, and then creates a root node of a DOM tree corresponding to html and creates the first node html.

In Step S106, the browser next calls script that is defined, by an extension, to be injected and executed at document_start.

In Step S108, after executing the document_start script of the extension, the browser continues parsing the webpage, and creates corresponding DOM nodes according to the nodes of the webpage.

In Step S110, after the browser encounters an html end tag of the webpage, the browser considers that DOM tree has been constructed.

In Step S112, browser then calls script that is defined by an extension to be injected and executed at document_end.

In Step S114, after executing the document_end script of the extension, the browser continues to wait for sub-resources (which may be image or iframe, etc.) of the webpage that have not been loaded.

In Step S116, when all of the sub-resources have been loaded, the browser considers the loading and parsing of the page as completed.

In Step S118, the browser continues to call script that is defined by an extension to be injected and executed at document_idle.

However, the three types of points in time for calling extension applications according to the existing technology may no longer meet the needs of diverse extension applications for modifying pages. Thus, a solution is needed.

### BRIEF SUMMARY OF THE DISCLOSURE

The present disclosure provides a method and apparatus for calling an extension, to at least solve the problem that the three types of points in time provided by related technology for calling an extension application during the parsing of a page can no longer meet the needs of diverse extension applications for modifying pages.

One aspect of the present disclosure includes a method for calling an extension.

In the method for calling an extension according to the present disclosure, an obtained webpage page text that includes one or more page tag character strings can be parsed. After a document body start tag character string in the webpage page text is parsed out, a predetermined extension corresponding to the document body start tag character string can be called.

Further, the document body start tag character string can include “<body”.

Further, after the document body start tag character string in the webpage page text is parsed out and before the predetermined extension corresponding to the document body start tag character string is called, the method includes the following process. A HyperText Markup Language (HTML) token can be parsed out from a document body tag in the webpage page text. According to the HTML token, a document object model (DOM) element corresponding to the document body tag in the webpage page text can be created.

Further, the predetermined extension corresponding to the document body start tag character string can be previously configured in an extension configuration document corresponding to the webpage page text, and the predetermined extension corresponding to the document body start tag character string can be called according to the extension configuration document.

Further, the calling of the predetermined extension corresponding to the document body start tag character string can include the following. It can be determined whether the predetermined extension corresponding to the document body start tag character string is included in the extension configuration document. When the predetermined extension corresponding to the document body start tag character string is included in the extension configuration document, the predetermined extension corresponding to the document body start tag character string can be called, and a created DOM element can be processed.

Further, before the document body start tag character string is parsed out, it can be checked whether a subtag exists in document head tags in the webpage page text. When it is checked that the subtag exists, the subtag can be parsed. By using information of the parsed subtag, the predetermined extension corresponding to the information can be called.

Another aspect of the present disclosure includes an apparatus for calling an extension. The apparatus can include a memory configured to store a predetermined extension, and a parsing module configured to parse an obtained webpage page text containing one or more page tag character strings. The apparatus can further include a calling module configured to, after a document body start tag character string in the webpage page text is parsed out, call a predetermined extension corresponding to the document body start tag character string from the memory.

Further, the memory is further configured to store an extension configuration document that contains a correspondence relationship between the document body start tag character string and the predetermined extension.

Further, the parsing module can be further configured to, after the document body start tag character string in the webpage page text is parsed out and before the predetermined extension corresponding to the document body start tag character string is called, parse out an HTML token from a document body tag in the webpage page text. The apparatus can further include a creating module configured to, according to the HTML token, create a DOM element corresponding to the document body tag in the webpage page text.

Further, the calling module can include a determining unit configured to determine whether the predetermined extension corresponding to the document body start tag character string is included in the extension configuration document. The calling module can further include a calling unit configured to, when an output of the determining unit is YES, call the predetermined extension and process the created document object model element.

Further, the apparatus can further include a checking module configured to, before the document body start tag character string is parsed out, check whether a subtag exists in document head tags in the webpage page text. When it is checked that the subtag exists, the parsing module can be further configured to parse the subtag, and the calling module can be further configured to, by using information of the parsed subtag, call the predetermined extension corresponding to the information.

Another aspect of the present disclosure includes a computer-readable medium containing program code executable by a processor. When executed by the processor, the program code can cause the processor to perform a process include the following process. An obtained webpage page text that includes one or more page tag character strings can be parsed. After a document body start tag character string in the webpage page text is parsed out, a predetermined extension corresponding to the document body start tag character string can be called.

By using the present disclosure, during the parsing of text from a target website by the page parser, a new point in time for calling can be added between a start tag character string of the text and an end tag character string of the text, to call a predetermined extension. Thus, the problem can be solved, where the three types of point in time provided by related technology for calling an extension application during the parsing of a page can no longer meet the needs of diverse extension applications for modifying pages. Accordingly, effects of more flexible modes for modifying a page, adaptability to needs of diverse extension applications and friendly user experience can be achieved.

### BRIEF DESCRIPTION OF THE DRAWINGS

The drawings described herein are used for providing further understanding of the present disclosure, and constitute a part of this application. The exemplary embodiments of the present disclosure and description thereof are used for explaining the present disclosure and do not constitute undue limitation for the present disclosure. In the drawings:

FIG. 1 depicts a flow diagram of point in time for injecting scripts during calling of an extension by a browser according to related technology;

FIG. 2 depicts a flow diagram of an exemplary method for calling an extension in accordance with various disclosed embodiments;

FIG. 3 depicts a flow diagram of another exemplary method for calling an extension in accordance with various disclosed embodiments;

FIG. 4 depicts a structure diagram of an exemplary apparatus for calling an extension in accordance with various disclosed embodiments; and

FIG. 5 depicts a structure diagram of another exemplary apparatus for calling an extension in accordance with various disclosed embodiments.

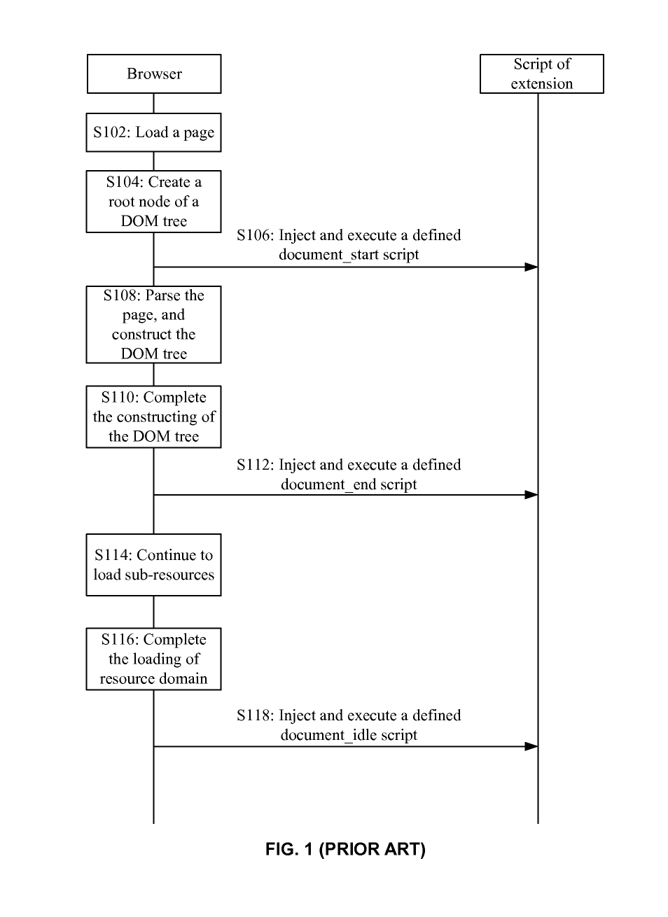

### DETAILED DESCRIPTION

Reference will now be made in detail to exemplary embodiments of the disclosure, which are illustrated in the accompanying drawings. It is to be noted that, in the case of no conflict, various embodiments and features in the various embodiments in the present disclosure can be combined with each other.

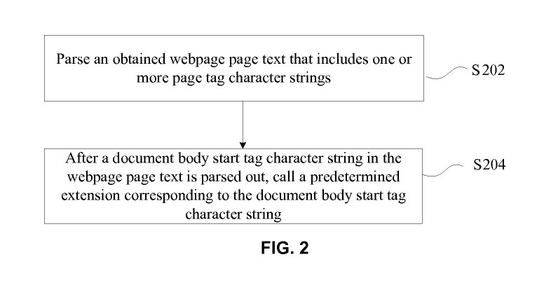

FIG. 2 depicts a flow diagram of an exemplary method for calling an extension in accordance with various disclosed embodiments. The method can be implemented by a browser that is on an apparatus such as a mobile terminal. As shown in FIG. 2, the method can include the following process(es).

In Step S202, a browser parses an obtained webpage page text that includes one or more page tag character strings. The webpage page text that includes the one or more page tag character strings can be received from a target website, or can be obtained from memory of the mobile terminal that has the webpage page text pre-stored or previously stored thereon.

Step S204, after a document body start tag character string in the webpage page text is parsed out, a predetermined extension corresponding to the document body start tag character string is called. The predetermined extension can be configured to correspond to the document body start tag.

The three types of point in time for calling extension applications during the parsing of a page according to related technology can no longer meet the needs of diverse extension applications for modifying pages. By using the method as shown in FIG. 2, after the document body start tag character string in the webpage page text is parsed out, a predetermined extension (e.g., an extension application) can be called. Thus, the configuring of a page displayed on a browser can be personalized according to various predetermined application programs, to improve user experience.

In one embodiment, the webpage page text can be a document formed by one or more HTML language tag character strings, the document being formed by a page parser of the browser after a page of the target website is loaded. For example, the document can include a Notepad (.txt) document. The page tag character string(s) can be, but are not limited to, one or more of the following including <html>, <head>, </head>, <body>, <div>, </div>, </body>, and </html>.

In various embodiments, the extension(s) can include, but are not limited to, at least one of the following including an extension for removing advertisement on a page, an extension for synchronizing bookmark(s), an extension for forum mode; an extension for screenshot.

Further, before Step S204, after the document body start tag character string in the webpage page text is parsed out and before the predetermined extension corresponding to the document body start tag character string is called, the following process(es) can be performed.

HyperText Markup Language (HTML) phrase (or token) can be parsed out from a document body tag in the webpage page text.

According to the HTML token, a document object model element corresponding to the document body tag in the webpage page text can be created.

After the document object model element corresponding to the HTML token is created, the browser can successfully start to call the predetermined extension.

Further, the predetermined extension corresponding to the document body start tag character string can be previously configured in an extension configuration document corresponding to the webpage page text. The predetermined extension corresponding to the document body start tag character string can be called according to the extension configuration document.

Further, in Step S204, the predetermined extension corresponding to the document body start tag character string can be called using the following method(s).

It can be determined whether the predetermined extension corresponding to the document body start tag character string is included in the extension configuration document.

When the predetermined extension corresponding to the document body start tag character string is included in the extension configuration document, the predetermined extension corresponding to the document body start tag character string can be called. The created document object model element can be processed.

Before the browser accesses a target website, according to various different needs for a page of the target website that is eventually displayed on the browser, various different extension applications can be configured at the three modification times in related technology and at the newly-added modification times in the present disclosure, respectively. Further, a correspondence relationship between a modification time and an extension application can be established, e.g., in a previously-configured extension configuration document. During the parsing of the webpage page text by the page parser of the browser, at various different modification times, different extension applications can be called, respectively, such that ways to modify a page can be more flexible and diversified.

During the parsing of each page tag character string, the page parser can create a document object model element. An extension application that is called can access and modify the created document object model element, in order to avoid causing runtime error(s).

For example, the document body start tag character string can include, but is not limited to a document body (body) tag character string, i.e., “<body”.

In one embodiment of the present disclosure, the ‘body’ tag character string is merely a most desired time to call an extension according to the present disclosure. An extension can also be called when other tag character string(s) are parsed out. For example, the other tag character string(s) can include a div tag character string.

Before the document body start tag character string is parsed out, the method may further include the following processes.

It can be checked whether a subtag character string (hereinafter referred to as subtag) exists in (or between) document head tags in the webpage page text. The subtag can include a document meta-information (meta) tag or a ‘script’ tag. For example, before parsing the ‘body’ start tag character string, the webpage parser of the browser can check whether a ‘meta’ tag character string or a ‘script’ tag (character string) exists in (or between) the document head tags.

When it is checked that a subtag exists, parse the subtag.

Then, by using information of the parsed subtag, a predetermined extension corresponding to the information can be called.

For example, when it is checked that a ‘meta’ tag character string (e.g., <meta name=“generator”content=“Discuz! X2”/>) exists, the ‘meta’ tag character string can be parsed. It can be parsed out that the ‘name’ attribute value is “generator”, and ‘content’ attribute value is “Discuz! X2”. Then, by using the information that is parsed out, an extension corresponding to the information can be called.

Alternatively, when the subtag is a ‘script’ tag, according to information that is parsed out from the ‘script’ tag character string, a ‘js’ script corresponding to the information can be called.

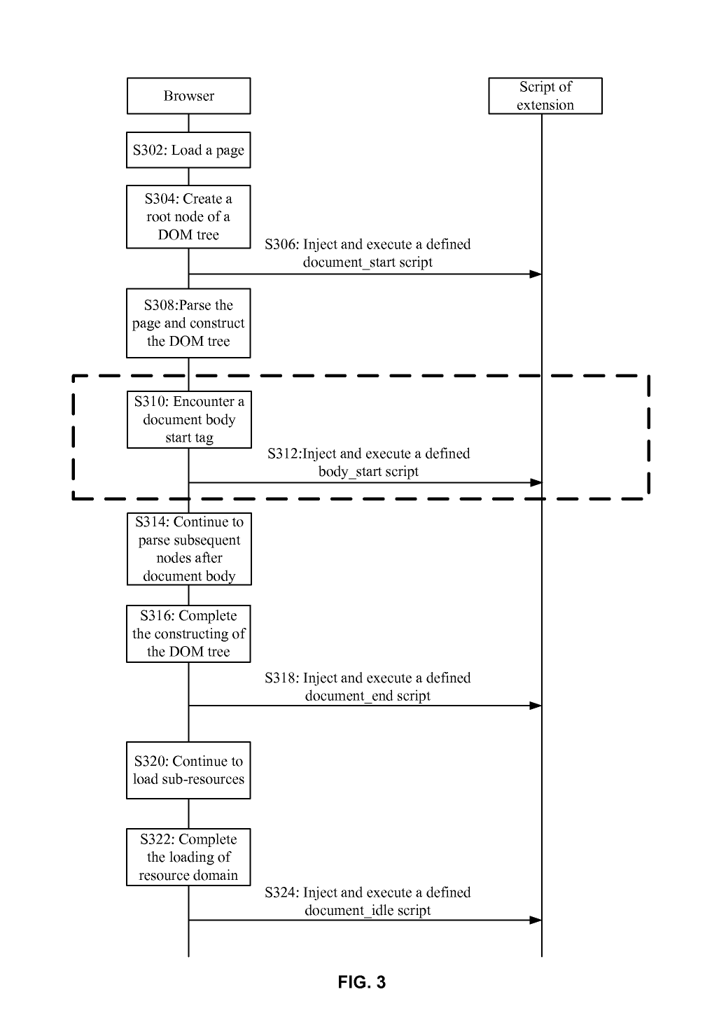

The above implementation process is further described with reference to calling an extension after a page parser parses out a document body ‘body’ tag character string, which is depicted in FIG. 3.

FIG. 3 depicts a flow diagram of another exemplary method for calling an extension in accordance with various disclosed embodiments. As shown in FIG. 3, the process flow may include the following process steps.

In Step S302, via HTTP protocol, the browser first requests webpage content from a target website. After responding content is received, the browser starts to prepare to parse the webpage content or page content. For example, the webpage content is:

<html>

<head> </head>
<body>

<div> ... </div>
<div> ... </div>

</body>

</html>

In Step S304, when a webpage parser or page parser of the browser parses an ‘html’ start tag (i.e., a page start tag character string), the browser knows that the page is an ‘html’ page, and then creates a root node of a DOM tree corresponding to ‘html’, and creates the first node ‘html’.

In Step S306, the browser then calls script that is defined, by an extension, to be injected and executed at document_start.

In Step S308, after executing the document_start script of the extension, the browser continues parsing the webpage, and creates corresponding DOM nodes according to the nodes of the webpage.

In Step S310, when the page parser of the browser parses the “<body” character string in the ‘body’ page tag character string <body onload=“doSomething( );”>, the page parser of the browser considers that the page parser has entered a state of being in the ‘body’ start tag. Next, the ‘body’ tag can be parsed, until after “>” is parsed, the page parser can consider that the ‘body’ start tag ends. According to the above character string, the page parser can parse out an html token. The name of the token is ‘body’. The token contains an attribute ‘onload’ having a corresponding attribute value of “doSomething ( );”. According to the ‘body token’, the page parser can create a ‘body’ element (HTMLBodyElement) of the document object model (DOM). At this time, the document body (body) element of the document object model has been created.

However, according to three points in time for calling an extension that are set in the existing technology, an extension may desires that, before parsing the document body (body) tag of the html page, the browser needs to check child element(s) of (or between) document head (head) tags and determine whether to inject specific JavaScript or CSS by determining child element information of ‘head’. For example, many forum websites are created based on a Discuz forum template. Then, the Discuz forum template may add in the ‘head’ tags a child element, i.e., a document meta-information (meta) tag. The document meta-information (meta) tag can be used for declaring page information, and has a ‘name’ attribute value set to be “generator”, a ‘content’ attribute value set to be “Discuz! X2”, as shown in the following code:

<meta name=“generator”content=“Discuz! X2”/>

Thus, the extension may desire to, when it is determined that such information exists, change the style of certain node(s), or even hide the entire document body (i.e., ‘body’ tags) and display the entire document body again when loading is completed. The above processes cannot be completed by merely relying on the above three conventional points in time for calling an extension.

To counter the above problems existing in related technology, a new point in time for injection of an extension at the beginning of a documentation body (body_start) can be added. That is, after the page parser parses out a document body (body) page tag character string, a script of an extension can be injected, to perform operations corresponding to the extension including, e.g., calling an extension for forum mode.

In Step S312, when the “<body” character string is parsed as above and the document body (body) element has been created, a “body_start” point in time for injection can be triggered. At this time, the browser can query whether the current extension configuration document includes the JavaScript or CSS script that needs to be executed at “body_start”. When the script(s) that need to be injected exist, the scripts can be injected and executed. At this time, according to the page content, element(s) before the ‘body’ element of the document object model (DOM) have already been created, and the ‘body’ element is also created. That is, the injected script can access those elements. However, the creating of DOM elements corresponding to the content after the ‘body’ start tag is not completed yet. That is, the script should not access those nodes. Otherwise runtime error(s) may occur. Thus, a JavaScript script can access/modify DOM elements before the DOM ‘body’ element. A CSS script can set the layout of the DOM nodes.

According to one embodiment of the present disclosure, a mobile phone browser that can support extension applications can describe operating rules of extensions via a configuration file Thanifest.json′, and can inject a script defined by an extension during the loading and parsing of a page.

The extension for forum mode as mentioned in the above embodiments is an important extension of a UC Browser. The extension can reformat a forum that can fit the UC Browser, such that the forum can fit the browser-mode of a mobile phone screen. In addition, unnecessary elements can be deleted, such that the content of the page can be more concise. The content of Thanifest.json′ can include:

{

“name”: “BBS Mode”,
“version”: “1.0.3”,
“content_scripts”: [{

“all_frames”: false,
“js”: [“uc_select.js”],
“matches”: [“http:// * / *”, “https:// * / *”],
“run_at”: “document_end”

}, {

“all_frames”: false,
“js”: [“verify.js”],
“matches”: [“http:// * / *”, “https:// * / *”],
“run_at”: “body_start”

}]

}

Thus, during the loading and parsing of a page by the UC browser, as long as the parsing of the ‘body’ tag character string is completed, the ‘verify.js’ script can be run. After the DOM tree is created, the ‘uc_select.js’ script can be run. Via a meta element, the ‘verify.js’ can determine whether the page is a Discuz forum. When the page is a Discuz forum, the ‘body’ (i.e., the document body) can be set to be invisible. By changing the structure of the original page, ‘uc_select.js’ can generate a forum-mode DOM structure and eventually re-display a forum-mode page, i.e., the page in forum mode.

Therefore, the above forum-mode extension can fully take advantage of point in time for injection which is the ‘body_start’, and enhance user's interactive experience. If the browser does not provide such an interactive interface, the forum-mode extension cannot change the display mode of the page during the loading or parsing of the page. After the loading or parsing of the page is completed, the page can be suddenly converted to a forum-mode page, which can leads to a sense of jumping of the page and reduce user experience.

In Step S314, subsequent nodes after ‘body’ continue to be parsed.

In Step S316, after the browser encounters an ‘html’ end tag of the webpage, the browser considers that the DOM tree has been constructed.

In Step S318, the browser then calls script that is defined by an extension to be injected at document_end.

In Step S320, after executing the document_end script of the extension, the browser continues to wait for sub-resources (which may be image or iframe, etc.) of the page that have not been completely loaded.

In Step S322, when all of the sub-resources have been loaded, the browser considers the loading and parsing of the page as completed.

In Step S324, the browser continues to call script that is defined by an extension to be injected and executed at document_idle.

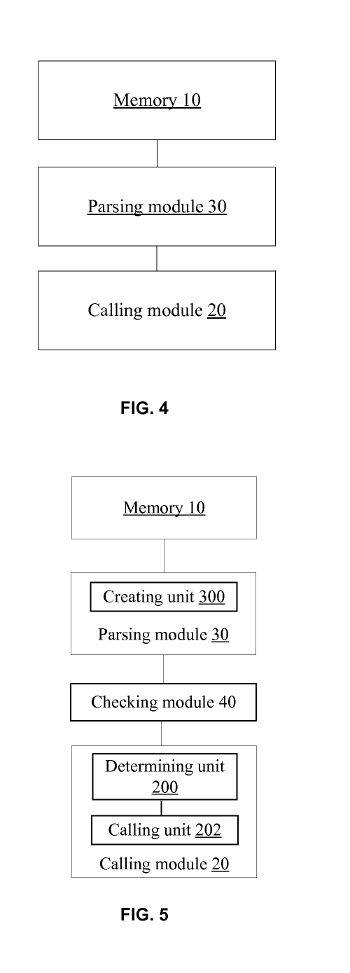

FIG. 4 depicts a structure diagram of an exemplary apparatus for calling an extension in accordance with various disclosed embodiments. As shown in FIG. 4, the apparatus for calling an extension can mainly include a memory 10 configured to store a predetermined extension that is configured to correspond to a document body start tag character string. The apparatus for calling an extension can further include a parsing module 30 configured to parse an obtained webpage page text containing page tag character string(s). The apparatus for calling an extension can further include a calling module 20 configured to, after a document body start tag character string in the page tag character string(s) in the webpage page text is parsed out, call a predetermined extension corresponding to the document body start tag character string.

Furthermore, the memory 10 can be further configured to store an extension configuration document that contains a correspondence relationship between the document body start tag character string and the predetermined extension.

By using the apparatus as shown in FIG. 4, based on the three existing points in time for calling an extension, a new point in time for calling an extension can be added, to meet the needs of diverse extension applications for modifying pages, such that user experience can be enhanced.

FIG. 5 depicts a structure diagram of another exemplary apparatus for calling an extension in accordance with various disclosed embodiments. As shown in FIG. 5, the parsing module 30 as depicted above can be further configured to, after the document body start tag character string in the webpage page text is parsed out and before the predetermined extension corresponding to the document body start tag character string is called, parse out HyperText Markup Language (HTML) token(s) from the document body tag in the webpage page text.

The apparatus can further include a creating module 300 configured to, according to the HTML token(s), create a document object model element corresponding to the document body tag in the webpage page text. In FIG. 5, the creating module 300 is shown to be included in the parsing module 30. In other examples of the present disclosure, the creating module 300 can also be located outside the parsing module 30.

Further, as shown in FIG. 5, the calling module 20 can further include a determining unit 200 configured to determine whether the predetermined extension corresponding to the document body start tag character string is included in the extension configuration document. The calling module 20 can further include a calling unit 202 configured to, when the determining unit 200 determines that the predetermined extension corresponding to the document body start tag character string is included in the extension configuration document, i.e., when the output of the determining unit 200 is YES, call the predetermined extension and process the created document object model element.

Further, the apparatus can further include a checking module 40 configured to, before the document body start tag character string is parsed out, check whether a subtag exists in or between document head tags in the webpage page text.

When it is checked that a subtag exists, the parsing module 30 is further configured to parse the subtag. In addition, the calling module 20 is further configured to call a predetermined extension corresponding to the information by using information of the parsed subtag.

The specific modes of operation between the various modules and the various units can refer to the embodiments as shown above in FIG. 3, and are not repeated here. Furthermore, the above apparatus can be can be arranged in a device with computing capabilities, including, e.g., smart phones, personal digital assistants (PDA), tablet PCs, or various smart handheld mobile terminals.

From the above description, it can be seen that the present disclosure can achieve the following technical results. By adding a new point in time for calling an extension between a document start tag character string and a document end tag character string, to meet the needs of diverse extension applications for modifying pages, users' needs of personalized configuration of pages can thus be met and user experience can be improved.

Obviously, a person skilled in the art should understand that the above-mentioned various modules or various steps in the present disclosure can be implemented using general-purpose computing apparatus, and can be focus on a single computing apparatus or distributed on a network formed by multiple computing apparatus. Optionally, the various modules or various steps can be implemented by programming code executable by a computing apparatus. Thus, the various modules or various steps can be stored on a storage apparatus to be implemented by the computing apparatus. The computing apparatus can include, e.g., a CPU. The computing apparatus can be configured on a handheld mobile terminal, e.g., mobile phone, PDA, tablet PC. In some cases, the shown or described steps can be executed in a sequence different from the sequence as depicted above, or order of the here herein, or may be made into various integrated circuit modules, respectively, or the multiple modules or steps among the above can be fabricated into a single integrated circuit module to be implemented. Thus, the present disclosure is not limited to any specific combination of hardware and software.

In addition, it should be noted that the described computer-readable storage device (e.g., memory) may be volatile memory or non-volatile memory, or may include volatile memory and nonvolatile memory. As a non-limiting example, nonvolatile memory can include read-only memory (ROM), programmable ROM (PROM), electrically programmable ROM (EPROM), electrically erasable programmable ROM (EEPROM), or flash memory. Volatile memory may include random-access memory (RAM) and the RAM may be used as external cache memory. As a non-limiting example, RAM can be produced in various forms such as synchronous RAM (SRAM), dynamic RAM (DRAM), synchronous DRAM (SDRAM), double data rate SDRAM (DDR SDRAM), enhanced SDRAM (ESDRAM), synchronous link DRAM (SLDRAM), and direct Rambus RAM (DRRAM). It is intended that the disclosed storage device includes but are not limited to these and other suitable types of memory.

Those skilled in the art understand that the disclosed various exemplary logic blocks, modules, circuits and algorithm steps can be implemented in electronic hardware, computer software or a combination thereof. In order to clearly illustrate the interchangeability between the hardware and software, the functions of the various exemplary components, blocks, modules, circuits and algorithm steps have been generally described. Whether the functions are implemented in hardware or software depends on the specific application and the design limitation imposed on the entire system. Those skilled in the art can use a variety of ways to realize the described functionalities for each specific application. However, such realization decision should not be interpreted as departing from the scope of the present invention.

The various illustrative logic blocks, modules, and circuits described herein can be implemented or executed by using the following components designed to execute the disclosed functionalities: general-purpose processor, digital signal processor (DSP), application specific integrated circuit (ASIC), field programmable gate array (FPGA) or other programmable logic device, discrete gate or transistor logic, discrete hardware components, or any combination of these components. The general-purpose processor can be a microprocessor or, alternatively, the processor can be any conventional processor, controller, microcontroller or state machine. The processor can also be a combination of computing devices, such as a combination of DSP and microprocessors, multiple microprocessors, one or more microprocessors integrated with a DSP core, or any other such configurations.

The disclosed methods or algorithm steps may be embodied in hardware directly, in software modules executed by the processor, or in a combination of both. The software modules can reside in RAM memory, flash memory, ROM memory, EPROM memory, EEPROM memory, registers, hard disk, removable disk, the CD-ROM, or any other form of storage medium known in the field. The storage medium can be coupled to the processor, such that the processor can read information from the storage medium and write information to the storage medium. Alternatively, the storage medium can be integrated with the processor. The processor and the storage medium may reside in an ASIC. The ASIC can reside in the user terminal. Also alternatively, the processor and the storage medium may reside as discrete components in the user terminal.

The foregoing is merely various embodiments of the present disclosure, and is not intended to limit the scope of the present disclosure. For a person skilled in the art, the present disclosure can have various modifications and changes. Any modification, equivalent replacement, improvement, etc., made within the spirit and principles of the present disclosure, should all be included within the scope of the present disclosure.

1. A method for calling an extension, comprising:
parsing an obtained webpage page text that includes one or more page tag character strings, the webpage page text sequentially including:
an html start tag;
a document body element containing a document body start tag and a document body end tag; and
an html end tag; and
after a document body start tag character string in the webpage page text is parsed out, calling a predetermined extension that is configured to correspond to the document body start tag character string, such that, prior to parsing of the webpage page text following the document body start tag, the predetermined extension is executed to modify a webpage that corresponds to the webpage page text.

2. The method according to claim 1, wherein the document body start tag character string includes “<body”.

3. The method according to claim 1, wherein, after the document body start tag character string in the webpage page text is parsed out and before the predetermined extension corresponding to the document body start tag character string is called, the method further includes:
parsing out a HyperText Markup Language (HTML) token from a document body tag in the webpage page text; and
according to the HTML token, creating a document object model (DOM) element corresponding to the document body tag in the webpage page text.

4. The method according to claim 1, wherein the predetermined extension corresponding to the document body start tag character string is previously configured in an extension configuration document corresponding to the webpage page text, and the predetermined extension corresponding to the document body start tag character string is called according to the extension configuration document.

5. The method according to claim 4, wherein the calling of the predetermined extension corresponding to the document body start tag character string includes:
determining whether the predetermined extension corresponding to the document body start tag character string is included in the extension configuration document; and
when the predetermined extension corresponding to the document body start tag character string is included in the extension configuration document, calling the predetermined extension corresponding to the document body start tag character string, and processing a created DOM element.

6. The method according to claim 5, further including:
before the document body start tag character string is parsed out, checking whether a subtag exists in document head tags in the webpage page text;
when it is checked that the subtag exists, parsing the subtag; and
by using information of the parsed subtag, calling the predetermined extension corresponding to the information.

7. An apparatus, comprising:
a memory configured to store a predetermined extension that is configured to correspond to a document body start tag character string;
a parsing module configured to parse an obtained webpage page text containing one or more page tag character strings, the webpage page text sequentially including:
an html start tag;
a document body element including a document body start tag and a document body end tag; and
an html end tag; and
a calling module configured to, after a document body start tag character string in the webpage page text is parsed out, call a predetermined extension corresponding to the document body start tag character string from the memory, such that, prior to parsing of the webpage page text following the document body start tag, the predetermined extension is executed to modify a webpage that corresponds to the webpage page text.

8. The apparatus according to claim 7, wherein the memory is further configured to store an extension configuration document that contains a correspondence relationship between the document body start tag character string and the predetermined extension.

9. The apparatus according to claim 8, wherein:
the parsing module is further configured to, after the document body start tag character string in the webpage page text is parsed out and before the predetermined extension corresponding to the document body start tag character string is called, parse out an HTML token from a document body tag in the webpage page text; and
the apparatus further includes:
a creating module configured to, according to the HTML token, create a DOM element corresponding to the document body tag in the webpage page text.

10. The apparatus according to claim 9, wherein the calling module includes:
a determining unit configured to determine whether the predetermined extension corresponding to the document body start tag character string is included in the extension configuration document; and
a calling unit configured to, when an output of the determining unit is YES, call the predetermined extension and process the created document object model element.

11. The apparatus according to claim 10, further including:
a checking module configured to, before the document body start tag character string is parsed out, check whether a subtag exists in document head tags in the webpage page text, wherein:
when it is checked that the subtag exists, the parsing module is further configured to parse the subtag, and the calling module is further configured to, by using information of the parsed subtag, call the predetermined extension corresponding to the information.

12. A computer-readable medium containing program code executable by a processor, wherein, when executed by the processor, the program code causes the processor to perform a process comprising:
parsing an obtained webpage page text that includes one or more page tag character strings, the webpage page text sequentially including:
an html start tag;
a document body element including a document body start tag and a document body end tag; and
an html end tag; and
after a document body start tag character string in the webpage page text is parsed out, calling a predetermined extension corresponding to the document body start tag character string, such that, prior to parsing of the webpage page text following the document body start tag, the predetermined extension is executed to m e text.

13. The computer-readable medium according to claim 12, wherein the document body start tag character string includes “<body”.

14. The computer-readable medium according to claim 12, wherein, after the document body start tag character string in the webpage page text is parsed out and before the predetermined extension corresponding to the document body start tag character string is called, the process further includes:
parsing out a HyperText Markup Language (HTML) token from a document body tag in the webpage page text; and
according to the HTML token, creating a document object model (DOM) element corresponding to the document body tag in the webpage page text.

15. The computer-readable medium according to claim 12, wherein the predetermined extension corresponding to the document body start tag character string is previously configured in an extension configuration document corresponding to the webpage page text, and the predetermined extension corresponding to the document body start tag character string is called according to the extension configuration document.

16. The computer-readable medium according to claim 15, wherein the calling of the predetermined extension corresponding to the document body start tag character string includes:
determining whether the predetermined extension corresponding to the document body start tag character string is included in the extension configuration document; and
when the predetermined extension corresponding to the document body start tag character string is included in the extension configuration document, calling the predetermined extension corresponding to the document body start tag character string, and processing a created DOM element.

17. The computer-readable medium according to claim 16, wherein the process further includes:
before the document body start tag character string is parsed out, checking whether a subtag exists in document head tags in the webpage page text;
when it is checked that the subtag exists, parsing the subtag; and
by using information of the parsed subtag, calling the predetermined extension corresponding to the information.

18. The apparatus according to claim 7, wherein the document body start tag character string includes “<body”.

19. The method according to claim 6, wherein the subtag that is checked and parsed for calling the corresponding predetermined extension includes a document meta-information tag or a script tag.

20. The computer-readable medium according to claim 17, wherein the subtag that is checked and parsed for calling the corresponding predetermined extension includes a document meta-information tag or a script tag.
